(19) United States
(12) Patent Application Publication
(10) Pub. No.: US 2008/0154449 A1
(43) Pub. Date: Jun. 26, 2008

(54) System, Method, and Computer-Readable Media For Monitoring Motion of Railcars In A Railroad Yard

(76) Inventor: John Edward Borntraeger, Viera, FL (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/677,084

(22) Filed: Feb. 21, 2007

Related U.S. Application Data
(60) Provisional application No. 60/870,899, filed on Dec. 20, 2006.

(51) Int. Cl. G06F 19/00; G05D 1/00

(52) U.S. Cl. 701/19; 701/30

(57) ABSTRACT

System, method and computer-readable media are provided for monitoring in a railroad yard effects of a railtrack having one or more curved track segments on motion characteristics of a railcar, as the railcar rolls along the railtrack due to gravity. The system may include impedance-measuring track circuitry arranged to monitor at least one motion parameter of the railcar as the railcar passes through a straight segment of the railtrack. The impedance-measuring track circuitry may be further arranged to monitor such at least one motion parameter of the railcar, as the railcar passes through a curved segment of the railtrack. The system may further comprise a processor coupled to the impedance-measuring track circuitry to determine a first coefficient of rollability of the railcar applicable to a straight railtrack segment, and a second coefficient of rollability of the railcar applicable to a curved railtrack segment.

### CROSS REFERENCE TO RELATED APPLICATIONS

This application claims the benefit of U.S. Provisional Application No. 60/870,899, filed Dec. 20, 2006, which is herein incorporated by reference in its entirety.

### FIELD OF THE INVENTION

The present invention is generally related to monitoring motion of railcars in railroad yards, and, more particularly, to system, method and computer-readable media for monitoring in a railroad yard effects of a railtrack having one or more curved track segments on motion characteristics of a railcar, as the railcar rolls along the railtrack due to gravity.

### BACKGROUND OF THE INVENTION

A railroad classification yard, such as hump yards, shunting yards and gravity yards, may be used at railroad freight stations where, for example, a railcar may be separated from one train of cars to be propelled by Earth's gravity to one of various classification tracks for coupling to another train of cars.

For example, a railcar may be pushed, or rolled down an incline, generally comprising a non-curved (e.g., tangent) railtrack segment, to build momentum and gain speed due to gravity to reach additional track segments that may include one or more curved track segments and may further include a series of railtrack switches that are controllable to direct the railcar to a desired classification track. Typically, each railcar may be classified in accordance with a respective destination of each railcar.

It is known that various parameters relative to the motion of the railcar may be monitored. For example, the position, speed and/or acceleration of the railcar may be monitored and these parameters may be in part controlled by retarders positioned at various locations along the railtrack, with the expectation that a railcar may reach its destination and connect with other railcars at an appropriate speed.

For example, if a given railcar is traveling too slowly that car may be stranded on the railtracks and will not reach its respective destination to connect with other railcars, or the railcar could be hit from behind by a railcar traveling faster, possibly damaging or derailing the railcars. Conversely, if a given railcar is traveling too fast that railcar may reach its respective destination moving too fast, or that railcar could hit the rear of a railcar traveling more slowly, in either case, possibly damaging or derailing the railcars.

Prior art techniques for monitoring motion of railcars due to gravity have not taken into account certain physical factors that can significantly affect the motion characteristics of a given railcar. More particularly, such prior art techniques have not accounted for effects on the motion of railcars due to one or more curved railtrack segments that may be present along the tracks. For example, some wheel axle designs may exhibit relatively fast motion in a straight track but may experience substantial resistance to rolling motion along a curved track segment. Sometimes, even for the same wheel axle design, substantial variation in motion characteristics along a curved track segment may occur from one railcar to another railcar while in a straight track the motion performance of the railcar may be generally uniform.

### BRIEF DESCRIPTION OF THE INVENTION

Generally, the present invention may fulfill the foregoing needs by providing, in one aspect thereof, a system for monitoring in a railroad yard effects of a railtrack having one or more curved track segments on motion characteristics of a railcar, as the railcar rolls along the railtrack due to gravity. The system may comprise impedance-measuring track circuitry arranged to monitor at least one motion parameter of the railcar as the railcar passes through a straight segment of the railtrack. The impedance-measuring track circuitry is further arranged to monitor such at least one motion parameter of the railcar, as the railcar passes through a curved segment of the railtrack. The system may further comprise a processor coupled to the impedance-measuring track circuitry to determine a first coefficient of rollability of the railcar applicable to a straight railtrack segment, and a second coefficient of rollability of the railcar applicable to a curved railtrack segment.

In another aspect thereof, the present invention may further fulfill the foregoing needs by providing, a method for monitoring in a railroad yard effects of a railtrack having one or more curved track segments on motion characteristics of a railcar, as the railcar rolls along the railtrack due to gravity. The method allows monitoring at least one motion parameter of the railcar as the railcar passes through a straight segment of the railtrack. The method further allows monitoring such at least one motion parameter of the railcar, as the railcar passes through a curved segment of the railtrack. A first coefficient of rollability of the railcar may be determined, and this first coefficient of rollability may be applicable to a straight railtrack segment. A second coefficient of rollability of the railcar may also be determined, and this second coefficient of rollability may be applicable to a curved railtrack segment.

In yet another aspect thereof, the present invention may still further fulfill the foregoing needs by providing a computer-readable media including computer program instructions for monitoring in a railroad yard effects of a railtrack having one or more curved track segments on motion characteristics of a railcar, as the railcar rolls along the railtrack due to gravity. The computer-readable media may comprise computer-readable code for monitoring at least one motion parameter of the railcar as the railcar passes through a straight segment of the railtrack. The computer-readable media may further include computer-readable code for monitoring such at least one motion parameter of the railcar as the railcar passes through a curved segment of the railtrack. Computer readable code may be configured for determining a first coefficient of rollability of the railcar applicable to a straight railtrack segment, and computer-readable code is configured for determining a second coefficient of rollability of the railcar applicable to a curved railtrack segment.

### BRIEF DESCRIPTION OF THE DRAWINGS

FIG. 1 is an elevational view of an example railroad classification yard, where operational control of railcars moving therein by gravity may benefit from aspects of the present invention.

FIG. 2 is a top schematic view of a railcar as rolling along a curved segment of the railtrack and monitored by impedance-measuring track circuitry, as may be arranged to monitor at least one motion parameter of the railcar, as the railcar passes through the curved segment of the railtrack.

### DETAILED DESCRIPTION OF THE INVENTION

In accordance with one or more embodiments of the present invention, systems, methods and computer-readable media are described for monitoring motion of railcars due to gravity. Aspects of the present invention innovatively account for certain physical factors of the railtrack, such as curves, that can significantly affect the motion characteristics of a given railcar. In the following detailed description, numerous specific details are set forth in order to provide a thorough understanding of various embodiments of the present invention. However, those skilled in the art will understand that embodiments of the present invention may be practiced without these specific details, that the present invention is not limited to just the depicted embodiments, and that the present invention may be practiced in a variety of alternative embodiments. In other instances, methods, procedures, and components known to those skilled in the art have not been described in detail for the sake of avoiding unnecessary and burdensome description.

Furthermore, various operations may be described as multiple discrete steps performed in a manner that is helpful for understanding embodiments of the present invention. However, the order of description should not be construed as to imply that these operations need to be performed in the order they are presented, nor that they are even order dependent. Moreover, repeated usage of the phrase “in one embodiment” does not necessarily refer to the same embodiment, although it may. Moreover, unless specifically stated any use of the terms first, second, etc. do not denote any limiting order or importance, but rather the terms first, second, etc. are used to distinguish one element from another. Lastly, the terms “comprising”, “including”, “having”, and the like, as used in the present application, are intended to be synonymous unless otherwise indicated.

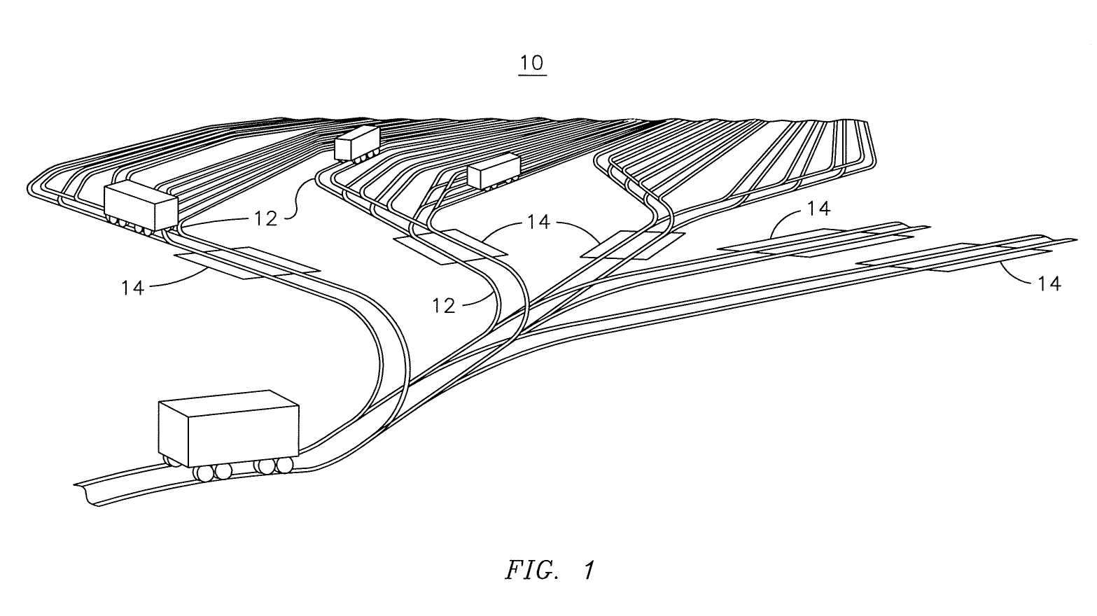

The inventor of the present invention has recognized that the presence of one or more curved railtrack segments 12 (FIG. 1) as may be encountered in railtracks disposed on a railroad yard 10, such as a railroad classification yard, including hump yards, shunting yards and gravity yards, can substantially affect the motion characteristic of a railcar being propelled on the track due to a force caused by Earth's gravity. Accordingly, the inventor of the present invention proposes an innovative solution for monitoring motion of railcars that takes into account the fact that the railtracks may include one or more curved track segments that can significantly affect the motion characteristics of a given railcar.

Aspects of the present invention propose utilization of commercially-available impedance-measuring track circuitry as may be configured in accordance with aspects of the present invention to determine motion characteristics of a free-rolling railcar as it negotiates one or more curved segments on a railtrack. It will be appreciated that other technologies, such as an onboard global positioning receiver, a suite of onboard accelerometers, etc., may be used to determine such motion characteristics, however, the utilization of impedance-measuring track circuitry may be attractive since this does not require any sensing devices onboard each railcar.

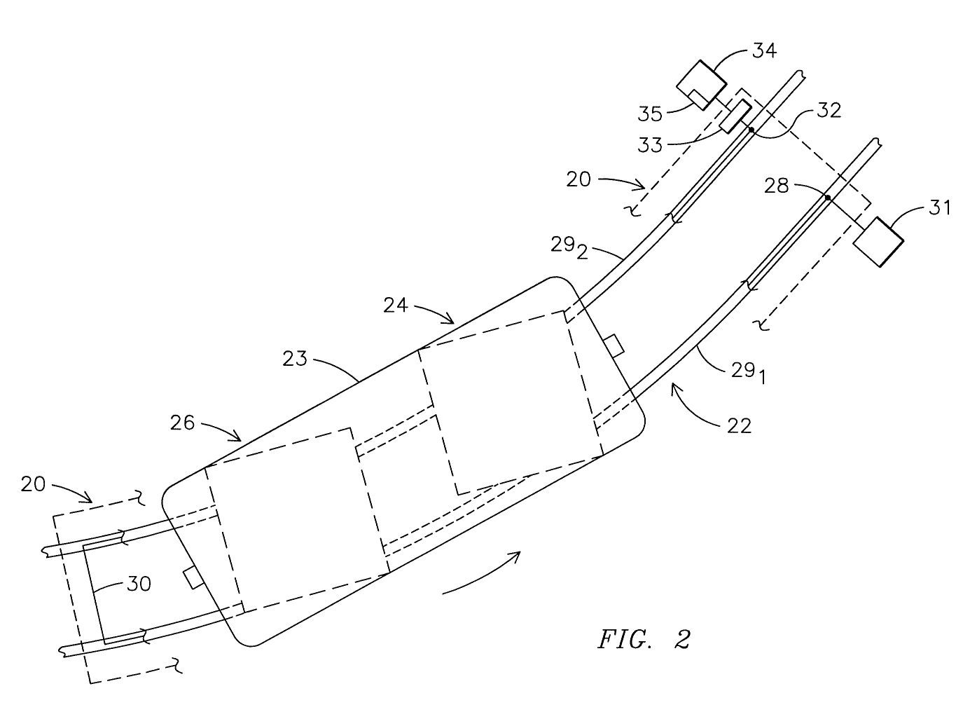

In one example embodiment, impedance-measuring track circuitry 20 (FIG. 2) may be arranged to measure a distance from a track circuit feed point to a shunting axle, as may be part of an axle truck of a moving railcar. A processor 34 (coupled to a receiver 33 that in turn coupled to impedance-measuring track circuitry 20) may be configured to determine one or more motion parameters, such as the velocity and/or acceleration of an approaching axle truck and thus the velocity and/or acceleration of the railcar. The impedance-measuring track circuitry may be arranged to initiate a monitoring of motion characteristics of the railcar as the railcar initially travels along a straight track segment. For example, the entire length of the railcar (or train of cars) may be along a straight track segment during this initial monitoring of velocity and/or acceleration.

The impedance-measuring track circuitry may be further arranged to monitoring and/or determining motion parameters (e.g., acceleration/deceleration of the railcar(s)) as a lead axle truck enters a curved track segment. This monitoring allows determining changes that may occur in acceleration/deceleration as the railcar negotiates the curved segment and may be used to quantitatively determine the respective characteristics of each railcar to roll along a curve. For example, a detection of a loss of velocity (e.g., determining an acceleration decrease or deceleration increase) may result from incremental resistance encountered as the lead wheel of the truck edges against the rail. The inability of the truck to freely rotate to follow a curved track segment may result in an increase of a flange resistance and a subsequent loss of velocity. For example, a determination of the acceleration/deceleration rates prior to and during travel of the railcar along a curved track segment will precisely determine the individual motion characteristics of each railcar, such as a first coefficient of rollability along a straight track and a second coefficient of rollability parameter along a curved track. This data can be processed by processor 34 to more accurately and consistently predict the velocity of the railcar at various points as the railcar rolls to a selected coupling destination since the track characteristics, (e.g., number of curved track segments, radii of curvature of the curved track segments, etc.) of any selected route may be readily established a priori and such track characteristics may be stored in a suitable storage device 35 that may be coupled to the processor.

It is further contemplated that motion data processed in accordance with aspects of the present invention may be used for controlling one or more retarders 14 (FIG. 1), such as group retarders as may positioned at various locations along the railtrack, to ensure that a railcar may reach its destination and connect with other railcars at an appropriate speed, (approximately 4.5 miles/hr in one example embodiment).

In one example embodiment, one may initially determine velocity and/or acceleration as the railcar is rolling along a straight track. Since one can readily determine where a curve segment starts and how long the railcar is, then one can precisely determine when a first truck (e.g., the front truck) of the railcar enters the curve segment and if then one detects that the railcar starts to slow down at a faster rate (or not accelerating as much), then this will be an indication that the railcar is encountering rolling resistance along the curve. Moreover, in the event that further decreases in acceleration are detected upon a second truck (e.g., the rear truck) entering the curve then this additional information further facilitates to quantify the rolling motion characteristics of the railcar along the curve. It will be appreciated that this information is useful to determine how to control railcar speed by way of retarders 14 for the remainder of a selected route. For example, because one has a priori knowledge of the route, (e.g., the number of curves that railcar has to pass to reach its destination, etc.) and having established the rolling characteristics of the railcar both along a straight track and along a curved segment, then one can more reliably and accurately predict the coupling speed of the railcar.

In an embodiment shown in FIG. 2, a system, as may be configured for determining effects on the motion of railcar due to one or more curved railtrack segments that may be present along a railtrack, may comprise one or more impedance-measuring track circuitry 20. FIG. 2 shows a curved segment of a track 22 disposed in a classification yard and impedance-measuring track circuitry 20 integrated on the track 22. In one example embodiment, such a system may include impedance-measuring systems whose principles of operation would be well understood by one skilled in the art.

As shown in FIG. 2, a railcar 23 may be within impedance-measuring track circuitry 20. In one example embodiment, railcar 23 may comprise two axle trucks, such as front axle truck 24 and a rear axle truck 26, each in turn including two-wheel axles. It will be understood that aspects of the present invention are not limited to railcars having any particular axle truck design and/or a given number of such trucks.

In one example embodiment, impedance-measuring track circuitry 20 may include a feed point 28 at which an alternating electrical current, for example, is introduced to the track 22 from a suitable electrical source 31. A first rail 29, and a shunt 30 may be disposed to electrically couple the first rail to a second rail 292. As will be readily understood by one skilled in the art, impedance-measuring track circuitry 20 may be configured to provide an electrical current from the shunt to receiver 33 connected to a second rail 292 at a connecting point 32. The receiver 33 may be in electrical communication with processor 34 to monitor impedance changes detected by impedance-measuring track circuitry 20.

Receiver 33 is coupled to processor 34 that in turn may be coupled to (or be part of) a railroad yard monitoring system (not shown). Processor 34 may include a storage device 35 storing data relative to impedance levels or values that are associated with distance measurements. For example, the data may include impedance values or levels associated with a distance an axle truck is from receiver connection point 32 and/or feed point 28. The data may further include track characteristics, (e.g., number of curved track segments, radii of curvature of the curved track segments, etc.) of any selected route. For readers desirous of background information regarding basic principles of operation of impedance-measuring track circuitry reference is made to U.S. provisional application Ser. No. 60/870,899 titled “A System And Method For Measuring The Wheelbase Of A Railcar”.

In one example embodiment, shunt 30 may be disposed sufficiently far away from the electrical connection points 28 and 32 so that when the car passes over the shunt and is within the track circuit (e.g., presence of railcar is being detected and speed calculated), the car is initially traveling on a tangent track. This allows determining how the car performs on a tangent track. Then the first truck enters the curve and a change in acceleration is detected. This provides information as to how that first truck negotiates curves. Then the rear truck enters the curve and in the event the car acceleration varies again, then this provides information regarding how the second truck handles the curve. The foregoing sequence may occur inside a single track circuit provided shunt separation is sufficiently spaced apart from the electrical connection points 28 and 32.

Thus, in this example embodiment, the length of the track circuit from connections 28 and 32 to the shunt would comprise some tangent (straight) track and some curvature as well. Moreover, each of those track segments should be long enough to detect the value of acceleration with a suitable level of confidence. Also the distance from the beginning of the curve to the connection points 28 and 32 should be longer than the length of the car. Let us say the car is 80 feet long. This would suggest that in this example the track circuit may have a length ranging from approximately at least 120 feet to approximately at least 160 feet long. It will be appreciated that the longer the period (e.g., longer track segment) for monitoring motion data, then the monitored motion data may exhibit relatively higher accuracy.

In this example embodiment, the separation from shunt location to the beginning of the curved track may range from approximately 20 feet to approximately 40 feet to obtain a relatively accurate measurement of how the car behaves on a tangent track (this assumes both trucks are in the tangent track). It will be appreciated that an incremental level of accuracy may be gained if the tangent segment is as long as, or longer than the length of the car. Under the foregoing example assumptions, the distance from that point (e.g., beginning of the curve) to the electrical connection points 28 and 32 may be equal to the length of the car plus another suitable spacing (e.g., 20 to 40 feet) for monitoring an effect of the curve on a second truck. In this manner one may determine how the first truck (upon reaching the curve) affects the rate of acceleration and when the rear truck enters the curve one would provide another spacing (e.g., 20 to 40 feet) to determine how the car rear truck (when in the curve) affects the acceleration. It will be appreciated that each of these measurements may be taken with respect to the first axle. In this case when that rear truck enters the curve, one is still measuring velocity of the lead axle of the first truck (e.g., axle closest to the 28 and 32) connection points. It will be appreciated that aspects of the present invention are not limited in any manner to the foregoing example distances. The foregoing example is just provided to illustrate some practical considerations.

In operation, one example embodiment provides a system for monitoring in a railroad yard effects of a railtrack having one or more curved track segments on motion characteristics of a railcar, as the railcar rolls along the railtrack due to gravity. The system may include impedance-measuring track circuitry arranged to monitor at least one motion parameter of the railcar as the railcar passes through a straight segment of the railtrack. The impedance-measuring track circuitry may be further arranged to monitor such at least one motion parameter of the railcar as the railcar passes through a curved segment of the railtrack. The system may further include a processor coupled to the impedance-measuring track circuitry to determine a first coefficient of rollability of the railcar applicable to a straight railtrack segment and a second coefficient of rollability of the railcar applicable to a curved railtrack segment.

A storage device coupled to the processor may be used for storing railtrack characteristics including each straight railtrack segment and each curved railtrack segment to be encountered along a railtrack route selected for the railcar. The processor may be configured to calculate motion characteristics of the railcar along the railtrack route selected for the railcar by processing the first and second coefficients of rollability of the railcar with respect to the railtrack characteristics of the selected railtrack route in the storage device. The processor may be configured to generate a retarder control signal applied to one or more retarders positioned along the railtrack route selected for the railcar to adjust velocity of the railcar along the selected railtrack route. The control signal may be based on the calculated motion characteristics of the railcar along the railtrack route selected for the railcar.

In one example embodiment, the impedance-measuring track circuitry may be configured to monitor the motion parameter of the railcar as the railcar passes through the curved segment of the railtrack by monitoring changes in the motion parameter of the railcar as a first axle truck of the railcar passes through the curved segment. The impedance-measuring track circuitry may be further configured to monitor the motion parameter of the railcar as the railcar passes through the curved segment of the railtrack by monitoring further changes in the motion parameter of the railcar as a second axle truck of the railcar passes through the curved segment.

Another example embodiment provides a method for monitoring in a railroad yard effects of a railtrack having one or more curved track segments on motion characteristics of a railcar, as the railcar rolls along the railtrack due to gravity. The method may allow monitoring at least one motion parameter of the railcar as the railcar passes through a straight segment of the railtrack. The method may further allow monitoring such at least one motion parameter of the railcar, as the railcar passes through a curved segment of the railtrack. A first coefficient of rollability of the railcar may be determined, and this first coefficient of rollability may be applicable to a straight railtrack segment. A second coefficient of rollability of the railcar may also be determined, and this second coefficient of rollability may be applicable to a curved railtrack segment. The monitoring of the at least one motion parameter of the railcar as the railcar passes through the curved segment of the railtrack may include monitoring changes in the at least one motion parameter of the railcar as a first axle truck of the railcar passes through the curved segment. The monitoring of the at least one motion parameter of the railcar as the railcar passes through the curved segment of the railtrack may include monitoring further changes in the at least one motion parameter of the railcar as a second axle truck of the railcar passes through the curved segment.

The method may allow storing railtrack characteristics including each straight railtrack segment and each curved railtrack segment to be encountered along a railtrack route selected for the railcar. The method may further allow calculating motion characteristics of the railcar along the railtrack route selected for the railcar by processing the first and second coefficients of rollability of the railcar with respect to the railtrack characteristics of the selected railtrack route.

The method may allow generating a retarder control signal applied to one or more retarders positioned along the railtrack route selected for the railcar to adjust velocity of the railcar along the selected railtrack route. The control signal may be based on the calculated motion characteristics of the railcar along the railtrack route selected for the railcar.

Still another example embodiment provides a computer-readable media including computer program instructions for monitoring in a railroad yard effects of a railtrack having one or more curved track segments on motion characteristics of a railcar, as the railcar rolls along the railtrack due to gravity. The computer-readable media may include computer-readable code for monitoring at least one motion parameter of the railcar as the railcar passes through a straight segment of the railtrack. The computer-readable media may further include computer-readable code for monitoring such at least one motion parameter of the railcar as the railcar passes through a curved segment of the railtrack. Computer readable code may be configured for determining a first coefficient of rollability of the railcar applicable to a straight railtrack segment, and computer-readable code may be configured for determining a second coefficient of rollability of the railcar applicable to a curved railtrack segment.

The computer-readable media may include computer-readable code for storing railtrack characteristics including each straight railtrack segment and each curved railtrack segment to be encountered along a railtrack route selected for the railcar. The computer-readable media may further include computer-readable code for calculating motion characteristics of the railcar along the railtrack route selected for the railcar by processing the first and second coefficients of rollability of the railcar with respect to the stored railtrack characteristics of the selected railtrack route.

The computer-readable media may further include computer-readable code for generating a retarder control signal applied to one or more retarders positioned along the railtrack route selected for the railcar to adjust velocity of the railcar along the selected railtrack route. The control signal may be based on the calculated motion characteristics of the railcar along the railtrack route selected for the railcar.

Example embodiments of the present invention may provide solutions in various forms such as system, method, and computer software code, for improving operating capabilities of railcars in railroad yard. Persons skilled in the art will recognize that an apparatus, such as a data processing system, including a CPU, memory, I/O, program storage, a connecting bus, and other appropriate components, could be programmed or otherwise designed to facilitate the practice of the method of an exemplary embodiment of the invention. Such a system would include appropriate program means for executing the method.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A system for monitoring in a railroad yard effects of a railtrack having one or more curved track segments on motion characteristics of a railcar, as the railcar rolls along the railtrack due to gravity, the system comprising:
impedance-measuring track circuitry arranged to monitor at least one motion parameter of the railcar as the railcar passes through a straight segment of the railtrack, wherein the impedance-measuring track circuitry is further arranged to monitor said at least one motion parameter of the railcar as the railcar passes through a curved segment of the railtrack; and
a processor coupled to the impedance-measuring track circuitry to determine a first coefficient of rollability of the railcar applicable to a straight railtrack segment and a second coefficient of rollability of the railcar applicable to a curved railtrack segment.

2. The system of claim 1 further comprising a storage device. comprising railtrack characteristics including each straight railtrack segment and each curved railtrack segment to be encountered along a railtrack route selected for the railcar, the database being coupled to the processor.

3. The system of claim 2 wherein the processor is further configured to calculate motion characteristics of the railcar along the railtrack route selected for the railcar by processing the first and second coefficients of rollability of the railcar with respect to the railtrack characteristics of the selected railtrack route in the database.

4. The system of claim 1 wherein the processor is further configured to generate a retarder control signal applied to one or more retarders positioned along the railtrack route selected for the railcar to adjust velocity of the railcar along the selected railtrack route, the control signal based on the calculated motion characteristics of the railcar along the railtrack route selected for the railcar.

5. The system of claim 1 wherein the impedance-measuring track circuitry is configured to monitor said at least one motion parameter of the railcar as the railcar passes through the curved segment of the railtrack by monitoring changes in said at least one motion parameter of the railcar as a first axle truck of the railcar passes through the curved segment.

6. The system of claim 5 wherein the impedance-measuring track circuitry is further configured to monitor said at least one motion parameter of the railcar as the railcar passes through the curved segment of the railtrack by monitoring further changes in said at least one motion parameter of the railcar as a second axle truck of the railcar passes through the curved segment.

7. A method for monitoring in a railroad yard effects of a railtrack having one or more curved track segments on motion characteristics of a railcar, as the railcar rolls along the railtrack due to gravity, the method comprising:
monitoring at least one motion parameter of the railcar as the railcar passes through a straight segment of the railtrack;
monitoring said at least one motion parameter of the railcar as the railcar passes through a curved segment of the railtrack; and
determining a first coefficient of rollability of the railcar applicable to a straight railtrack segment; and
determining a second coefficient of rollability of the railcar applicable to a curved railtrack segment.

8. The method of claim 7 further comprising storing railtrack characteristics including each straight railtrack segment and each curved railtrack segment to be encountered along a railtrack route selected for the railcar.

9. The method of claim 8 further comprising calculating motion characteristics of the railcar along the railtrack route selected for the railcar by processing the first and second coefficients of rollability of the railcar with respect to the railtrack characteristics of the selected railtrack route in the database.

10. The method of claim 7 further comprising generating a retarder control signal applied to one or more retarders positioned along the railtrack route selected for the railcar to adjust velocity of the railcar along the selected railtrack route, the control signal based on the calculated motion characteristics of the railcar along the railtrack route selected for the railcar.

11. The method of claim 7 wherein monitoring said at least one motion parameter of the railcar as the railcar passes through the curved segment of the railtrack comprises monitoring changes in said at least one motion parameter of the railcar as a first axle truck of the railcar passes through the curved segment.

12. The method of claim 11 wherein monitoring said at least one motion parameter of the railcar as the railcar passes through the curved segment of the railtrack comprises monitoring further changes in said at least one motion parameter of the railcar as a second axle truck of the railcar passes through the curved segment.

13. A computer-readable media including computer program instructions for monitoring in a railroad yard effects of a railtrack having one or more curved track segments on motion characteristics of a railcar, as the railcar rolls along the railtrack due to gravity, the computer-readable media comprising:
computer-readable code for monitoring at least one motion parameter of the railcar as the railcar passes through a straight segment of the railtrack;
computer-readable code for monitoring said at least one motion parameter of the railcar as the railcar passes through a curved segment of the railtrack; and
computer readable code for determining a first coefficient of rollability of the railcar applicable to a straight railtrack segment; and
computer-readable code for determining a second coefficient of rollability of the railcar applicable to a curved railtrack segment.

14. The computer-readable media of claim 13 further comprising computer-readable code for storing railtrack characteristics including each straight railtrack segment and each curved railtrack segment to be encountered along a railtrack route selected for the railcar.

15. The computer-readable media of claim 14 further comprising computer-readable code for calculating motion characteristics of the railcar along the railtrack route selected for the railcar by processing the first and second coefficients of rollability of the railcar with respect to the railtrack characteristics of the selected railtrack route in the database.

16. The computer-readable media of claim 13 further comprising computer-readable code for generating a retarder control signal applied to one or more retarders positioned along the railtrack route selected for the railcar to adjust velocity of the railcar along the selected railtrack route, the control signal based on the calculated motion characteristics of the railcar along the railtrack route selected for the railcar.
